(19) United States
(12) Patent Application Publication
(10) Pub. No.: US 2008/0142349 A1
(43) Pub. Date: Jun. 19, 2008

(54) PROGRAMMABLE SWITCH AND METHOD FOR PROGRAMMING THE SAME

(75) Inventors: Yvan Lafontaine, Grand-Mere (CA); Bertrand Mallette, Mercier (CA); Martial Bilodeau, Grand-Mere (CA); Eric Gagnon, Shawinigan (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: TELEFLEX MEGATECH INC.

(21) Appl. No.: 11/933,070

(22) Filed: Oct. 31, 2007

Related U.S. Application Data
(60) Provisional application No. 60/855,406, filed on Oct. 31, 2006.

(51) Int. Cl. H01H 9/26

(52) U.S. Cl. 200/5 B

(57) ABSTRACT

A programmable switch, particularly adapted for vehicle dashboards. The programmable switch includes a control circuit and a microprocessor connected to the control circuit for controlling operation of the switch. The microprocessor operates the switch in either one of an operating mode and a programming mode. The switch also includes first and second microswitches connected to the control circuit. A simultaneous pressing of the first and second microswitches activates the programming mode. The switch also includes an actuator having a first button area and a second button area mounted over and in register with the first microswitch and the second microswitch respectively for alternately selecting either microswitch. The actuator is removable to provide simultaneous access to the first and second microswitches. Hence, the switch is programmable without the use of external tools. The switch structure can also be made waterproof. A method for programming such a switch is also disclosed.

### CROSS-REFERENCE TO RELATED APPLICATIONS

This application claims priority to U.S. provisional patent application Ser. No. 60/855,406, titled, “Waterproof and Programmable Rocker Switch,” filed Oct. 31, 2006, the disclosure of which is hereby incorporated by reference in its entirety.

### FIELD OF THE INVENTION

The present invention concerns electronic control components and more particularly concerns a stand-alone smart switch which includes all of the advantages of multiplexing technology while providing the <<look and feel>> of an electro-mechanical switch. The present invention also concerns a method for programming such a switch.

### BACKGROUND OF THE INVENTION

Multiplexing is a technology which allows a plurality of signals from a control panel to be sent to various destinations through one or a limited number of wires. This technology has become essential in the automotive and marine industries in order to add more and more complex control functions while limiting the space and weight of the wiring necessary to carry these functions out.

While command circuits in a multiplex system are all controlled electronically, there is still a reluctance in the industry to the use of keys or touch screens panels to interface with the controls, such technology being perceived as too “high-tech” by traditional users. This is particularly true in the marine field, where more traditional looking and feeling switches are still desired. Also, some application required specially located switches, and switching components should therefore be versatile and adapted to mounting in different places.

In the case of applications for the marine industry or other environment hostile to electronic components, it is also important for switches to be waterproof. Network switches send signals which are much weaker than switches directly connected to the load, and can therefore easily be disrupted by external factors.

Another advantage of multiplexing technology is the adaptability of the command controls. As all the control information travels through the same wires, the function of a given control component can be changed without the need for structural modifications to the system. Reprogramming current switches, when possible at all, however usually necessitates the use of a computer or electronic tool, which may not always be at hand, especially if reprogramming needs to be performed in the field.

There is therefore a need for a “smart” switch combining all of the advantages of multiplexing technology with the “look-and-feel” of electromechanical switching.

### SUMMARY OF THE INVENTION

In accordance with a first aspect of the invention, there is provided a programmable switch, particularly adapted for vehicle dashboards. The programmable switch includes a control circuit and a microprocessor connected to the control circuit for controlling operation of the switch. The microprocessor operates the switch in either one of an operating mode and a programming mode. The switch also includes a first microswitch and a second microswitch connected to the control circuit. A simultaneous pressing of the first and second microswitches activates the programming mode. The switch also includes an actuator having a first button area and a second button area mounted over and in register with the first microswitch and the second microswitch respectively. Pressing either of the first and second button areas activates the corresponding one of the first and second microswitches. The actuator is removable to provide simultaneous access to the first and second microswitches.

Hence, the switch is programmable without the use of external tools.

In accordance with another aspect of the invention, there is also provided a programmable multi-switching device. The device includes a control circuit and a microprocessor connected to the control circuit. The device also includes a plurality of switches connected to the control circuit. The microprocessor operates each switch in either one of an operating mode and a programming mode. Each switch includes a first microswitch and a second microswitch connected to the control circuit. A simultaneous pressing of the first and second microswitches of a selected switch activates the programming mode of the selected switch. Each switch also includes a removable actuator having a first button area and a second button area mounted over and in register with the first microswitch and the second microswitch respectively. Pressing either of the first and second button areas activates the corresponding one of the first and second microswitches respectively. The actuator is removable to provide simultaneous access to the first and second microswitches.

Hence, there is provided a multi-switching device in which each individual switch is programmable without the use of external tools.

In accordance with another aspect of the invention, there is also provided a method for programming a switch as described above. The method comprises the steps of a) removing the actuator; and b) simultaneously pressing the first microswitch and the second microswitch to activate the programming mode of the switch.

The method in accordance with the present invention therefore avoids any step of using an external tool to program a switch.

Other features and advantages of the present invention will be better understood upon reading of preferred embodiments thereof with reference to the appended drawings.

### BRIEF DESCRIPTION OF THE DRAWINGS

FIG. 1 is an exploded cross-sectional side view of a programmable switch according to a preferred embodiment of the present invention.

FIG. 2 is a perspective top view of the switch of FIG. 1, without the knob.

FIG. 3 is a perspective top view of the switch of FIG. 1, with the knob installed.

FIG. 4 is a bottom perspective view of the switch shown in FIG. 3.

FIG. 5 is an exploded cross-sectional side view of a programmable switch according to another embodiment of the present invention.

### DESCRIPTION OF PREFERRED EMBODIMENTS OF THE INVENTION

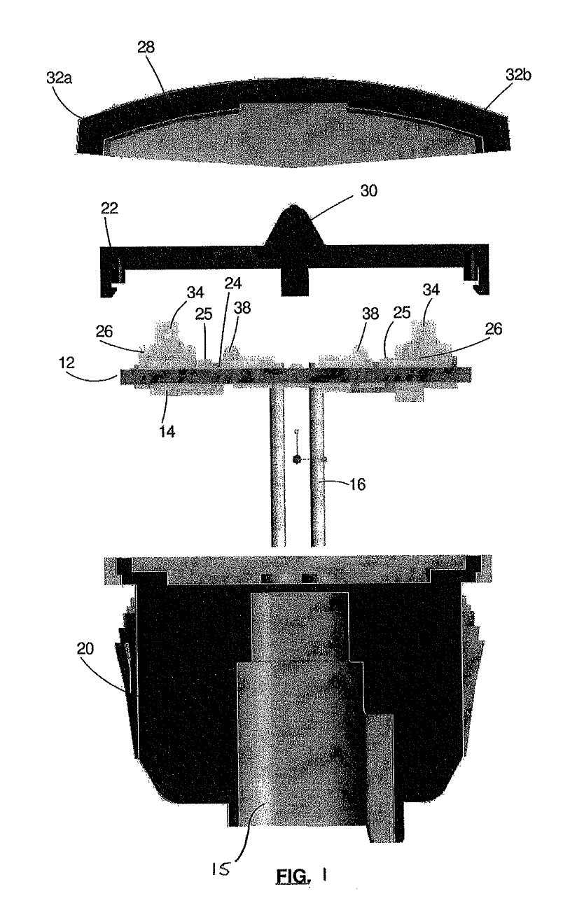

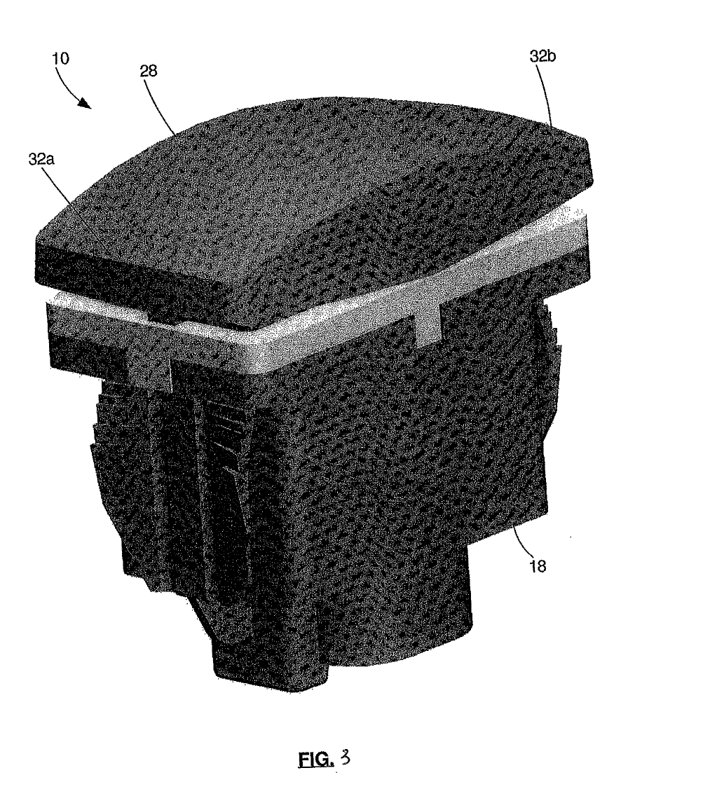

Referring to FIGS. 1 to 4, there is shown a programmable switch 10 according to a preferred embodiment of the present invention.

It is understood that the switch 10 may be used for any application where controls in communication with a multiplexing network may be required. The switch is particularly adapted to application in dashboards of vehicles such as boats, airplanes, cars, trucks, RVs, industrial equipment, etc. In one embodiment the switch of the present invention is completely waterproof, making it particularly adapted to the marine industry. Embodiments of the switch 10 may adapted to any appropriate multiplexing network, such as for example a LIN or CAN network.

As shown in FIG. 1, the programmable switch 10 includes a control circuit 12 and a microprocessor 14 connected to the control circuit 12 for controlling operation of the switch 10. It is understood that the control circuit may additionally be provided with any or all of the electronic components required for the operation of the switch 10. The microprocessor 14 operates the switch 10 in either one of an operating mode and a programming mode. The switch 10 also includes a first microswitch 26A and a second microswitch 26B connected to the control circuit 12. A simultaneous pressing of the first and second microswitches 26A,26B activates the programming mode. The switch 10 also includes an actuator 28 for alternately pressing the first microswitch 26A and the second microswitch 26B. The actuator 28 has a first button area 32A and a second button area 32B mounted over and in register with the first microswitch 26A and the second microswitch 26B respectively. Pressing either of the first and second button areas 32A,32B activates the corresponding one of the first and second microswitches 26A,26B. The actuator 28 is removable to provide simultaneous access to the first and second microswitches 26A,26B. Preferably, the actuator 28 is a rocker knob pivotally mounted over the first microswitch and the second microswitch. However, any actuator mechanism that allows alternate pressing of the first and second button areas may be used. These actuator mechanisms include button systems that block the use of a second button when the first button is actuated through any type of blocking system. Such an actuator mechanism must however be removable to provide simultaneous access to the first and second microswitches 26A,26B as mentioned above.

Throughout the present description, it is understood that the designations of “first” and “second” are used only in order to facilitate differentiation of components, and are not meant in any way to refer to a sequential order, particular positioning or level of importance of the corresponding components.

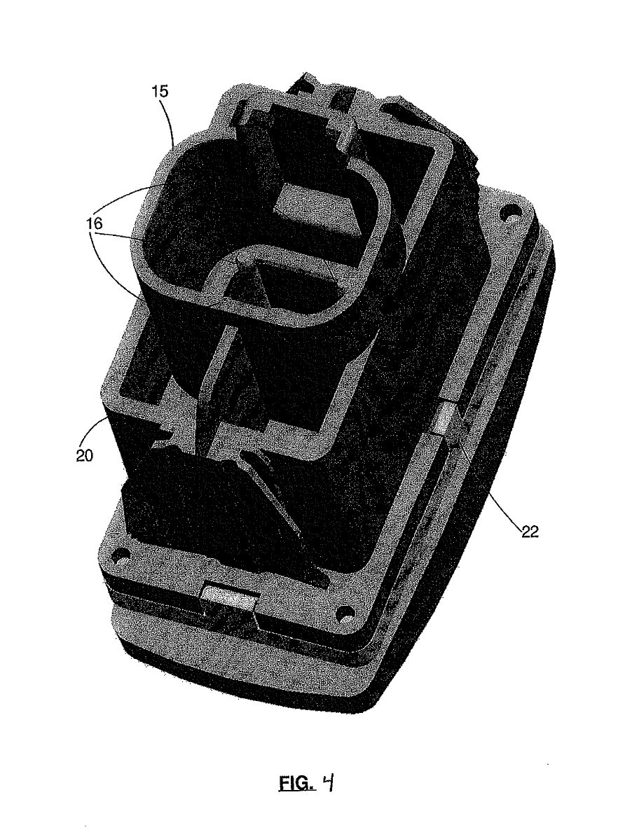

The control circuit is preferably embodied by a printed circuit board (PCB) of appropriate construction. In accordance with one embodiment of the invention, the control circuit 12 is in communication with the network through a connector 15 including a plurality of pins 16 projecting from the bottom surface of the circuit 12. In one embodiment the connector 15 includes six pins 16, separated in one set for incoming signals and in another set for outgoing signals. Each set includes plus and minus electrical power ports and a data port. In an alternative embodiment, as shown in FIG. 4, the connector 15 may include only three bi-directional pins 16 (+, −, data).

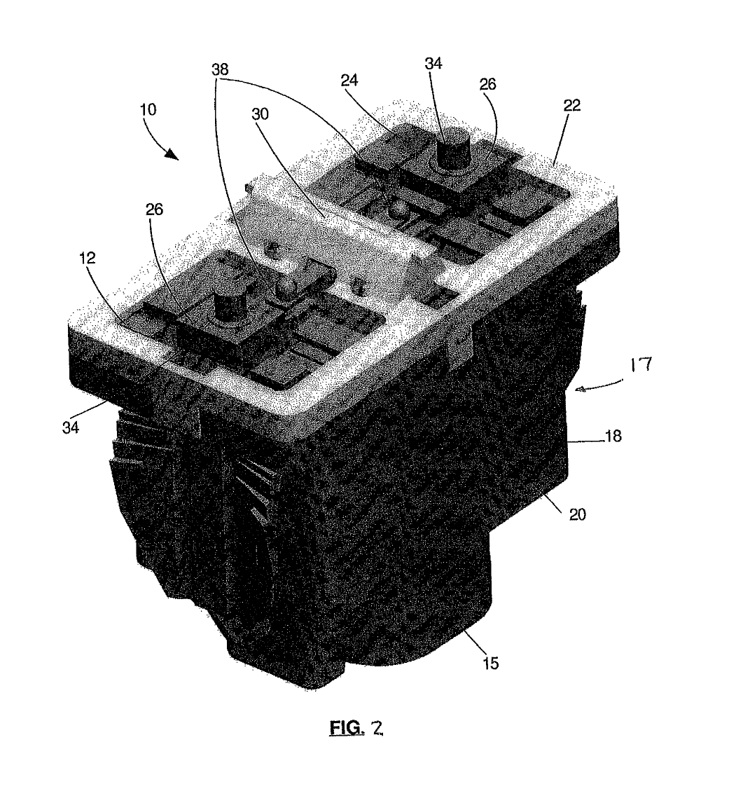

Preferably, as shown in FIG. 2, the programmable switch 10 further comprises a waterproof shell 17 surrounding the control circuit 12, the microprocessor 14 and the first and second microswitches 26A,26B. The waterproof shell 17 includes a housing 18 having an open end, and a waterproof layer 24 closing the open end. The waterproof layer 24 is preferably made of silicone poured over the control circuit 12 and cured thereon. The liquid silicon material is selected so that is safely protects the PCB without damaging it through corrosion. In one embodiment, the top surface of the control circuit is preferably covered with the cured liquid silicone, overmold with a water proof material, or coated with a water proof material providing for a complete waterproofing of the control circuit. The housing is preferably made of plastic and can be moulded into a single component or a plurality of closely fitting components. In the illustrated embodiment, the housing 18 includes a base portion 20 in which the control circuit 12 and connector 15 are received, and a top framing portion 22 which can be clicked in position over the base portion 20 and surround the control circuit 12 around its edges. Advantageously, in this embodiment no water or other damaging substance can reach the control circuit 12, making the switch 10 completely waterproof and therefore particularly suited to applications in the marine industry.

At least one pair of micro-switches 26 are provided on the control circuit 12. It will be noted that in the illustrated embodiments, the switch 10 is a single switch, therefore including a single pair of micro-switches 26. It will be however readily understood by one skilled in the art that the concepts of the present invention can be extended to a programmable multi-switching device where a single control circuit 12 controls a plurality of switches functioning as the single switch. Alternately, the single control circuit 12 could control a plurality of cross-shaped switches or navigation keys that would also require removal of the actuator before entering programming mode.

An actuator 28 is provided for each pair of micro-switches 26. In the illustrated embodiment, the actuator 28 is a rocker knob. The programmable switch includes a pivot structure 30 supporting the knob 28. The rocker knob 28 extends over the control circuit 12. Preferably, the pivot structure is part of the housing 18, and in the illustrated embodiment is integrally moulded as part of the top framing portion 22 thereof. In this manner, pressing each extremity 32a, 32b of the rocker knob 28 will respectively activate one of the micro-switches 26 of a given pair. Preferably, the rocker knob 28 is mounted in such a manner as to automatically return to a neutral position after pressure on one of its extremities 32a, 32b is removed. Preferably, the switch further includes knob positioning means for positioning the knob in this neutral position. The knob positioning means may include any mechanism comprising a spring or any other resilient structure. However, the present invention could be extended to switches where the rocker knob remains in contact with a given micro-switch 26 after activation.

Each micro-switch 26 is connected to the microprocessor 14 so that when a given micro-switch is activated, an appropriate signal is sent through the multiplexing network to activate a function associated with that particular micro-switch 26. Any appropriate functions could be linked to the switch 10 of the present invention, such as motor controls, light control, menu scrolling in remote displays, actuators, pumps, aerator, hvac control, radio control, etc.

It will be understood by one skilled in the art that an advantageous feature of the switch of the present invention is the capability to be linked to one or more functions instead of physical electrical loads, as is the case with traditional switches. This is best illustrated by an example from the marine industry. Activating one of the micro-switches once may activate the Navigation and Anchor Light. If the micro-switch is pressed again, the Navigation Light is turned off, and only the anchor light remains ON. At next activation both lights are turned OFF. In addition, a switch status light can blink to advise the user that one of the lights (Navigation or Anchor) is blown. This provides a very big advantage over traditional switches on the market.

The same switch can be used as momentary, toggle, tri-state, etc. Since the switch status is driven by the Network Master, there is no limit on available applications. The switch status can be turned ON/OFF or blink at various speeds at any time to give useful information to the user.

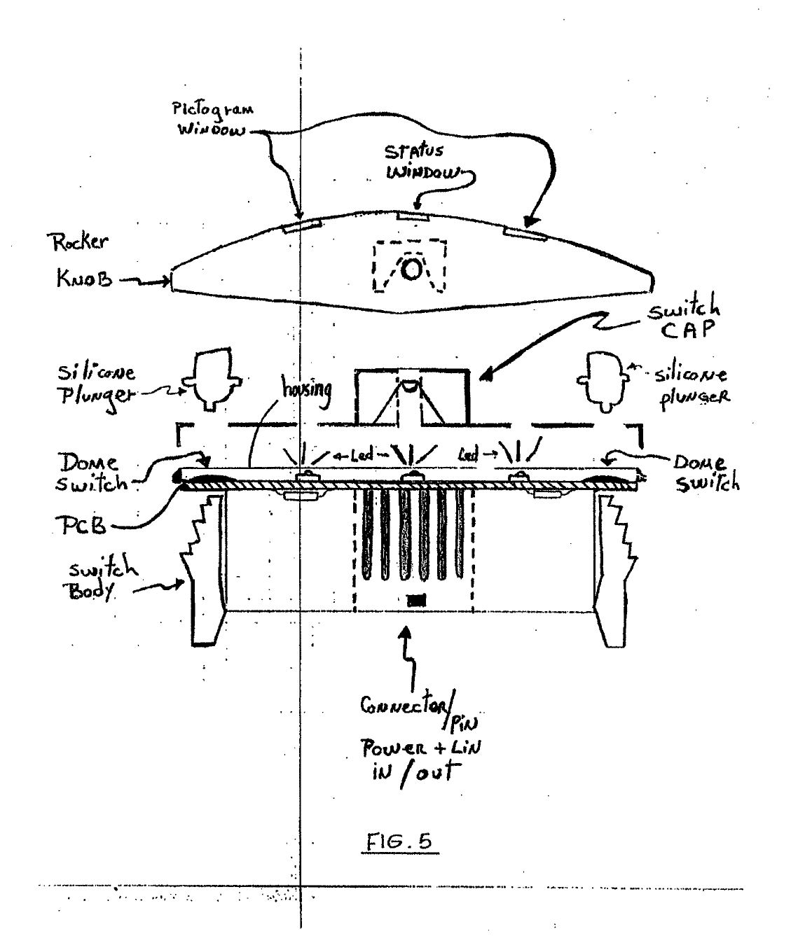

In the embodiment of FIGS. 1 to 4, the micro-switches 26 are tact type micro-switches which are preferably provided with a silicone top button, making them intrinsically waterproof. Alternatively, as shown in FIG. 5, the micro-switches 26 may be of a dome type and a silicone plunger 36 is mounted over each micro-switch 26. The plungers 36 are preferably held in place by a portion of the housing 18 designed for this purpose. Pressing on one extremity 32a or 32b of the rocker knob 28 therefore moves the corresponding plunger 36 downward until it contacts the corresponding dome micro-switch 26, therefore activating it.

In accordance with another aspect of the invention, the control circuit 12 preferably further includes a status indicating light 38 in association with each of the first and second microswitches. The actuator 28 further includes a first pictogram window and a second pictogram window in register with the status indicating light associated with each of the first and second microswitches, respectively. In this embodiment, the actuator 28 preferably has one or more transparent or translucid windows 40 aligned with the status indicating light 38 to allow illumination therefrom to be seen from the outside of the switch 10. The status indicating light 38 may be activated by the microprocessor 14 when a corresponding micro-switch 26 is properly activated, as well known in the art. Alternatively, and more preferably the status indicating light 38 may be activated by the microprocessor 14 when a signal is received from a multiplexing network, confirming that the switching function to which the corresponding micro-switch 26 is associated has been carried out. The status light level is preferably adjustable following reception of a network command to match various needs or applications. The control circuit may also be provided with back-lighting components 25 and the rocker knob with pictogram windows in association therewith. The backlight level may also be adjusted following reception of a network command to match backlight level of others instruments.

In one preferred embodiment, by way of example only, each micro-switch is fitted with a backlight LED and a Status LED. Switches can be programmed to use a certain color of LED for pictogram backlighting for night operation and once accessory mode is active, a brighter LED in a different color can override the backlight LED to provide status indication using the pictogram—or- use the other switch's bright status LED to provide status indication through a status bar etched/printed on the bottom portion of the switch.

In accordance with another aspect of the invention, the microprocessor includes instructions so that the switch 10 is preferably programmable without the use of external tools. This is accomplished by removing the actuator 28 from the switch 10, and simultaneously pressing the two micro-switches 26A,26B for a predetermined period of time within a range of 3 to 8 seconds, preferably 5 seconds, to activate a programming mode. As will be readily understood, the programming mode could not be accidentally activated when the actuator is in position on the switch as it would be impossible for both micro-switches 26A,26B to be activated at the same time in such circumstances. The predetermined period of time is also selected so that accidentally entering the programming mode is unlikely.

Preferably, for the purposes of programming the switch, the microprocessor includes a non-volatile memory storing a programming node identification label associated with the switching function provided by the switch. The microprocessor further includes a programming module for modifying the programming node identification label upon receiving a predetermined sequence of signals from the first and second microswitches when the switch is in programming mode.

Preferably, when in programming mode, the programming module resets the programming node identification label to a reset value upon activation of the first microswitch. The programming module can then increment the programming node identification label by an increment value upon activation of the second microswitch.

Preferably, according to one embodiment of the invention, a first and a second status indication light are mounted on the control circuit and controlled by the microprocessor. These first and second status indication lights are respectively associated with the first and second microswitches. When in programming mode, the microprocessor commands these indication lights to provide feedback on the programming of the switch. This feedback could for example correspond to any appropriate successive activations of the first and/or second identification light, according to a predetermined code. For example, the first and second status indication lights may be activated for a predetermined period of time when the switch transitions between the operating mode and the programming mode. The first status indication light can also for example blink a number of times equal to the programming node identification label after the programming node identification label is modified by the module.

Preferably, the microprocessor transitions the switch from the programming mode to the operating mode upon a continuous pressing of a predetermined one of the first and second microswitches for a predetermined period of time.

The above-described switch can also therefore be associated with a method of programming a switch. Hence, in accordance with another aspect of the present invention, there is provided a method for programming a switch comprising a number of steps, to which a number of optional steps may be added.

Generally, the method includes the steps of a) removing the actuator, and b) simultaneously pressing the first the second microswitches to activate the programming mode of the switch.

Once in programming mode, the method preferably includes an additional step of c) modifying the programming node identification label associated with the switch. This may be accomplished through pressing the first and second microswitches in a predetermined sequence. The first and second microswitches are preferably each assigned a specific function to assist this process. For example, the first microswitch could be assigned a reset function whereas the second microswitch is used to modify the programming node identification label. In this example, the predetermined sequence may therefore include first resetting the programming node identification label to a reset value, for example zero, through activation of the first microswitch, and incrementing the programming node identification label by at least one increment value, such as one integer, through activation of the second microswitch.

Preferably, the method includes an additional step of providing feedback on the programming of the switch by activating either the first or the second status indication light or both. As explained above, in one example, both status indication lights are activated for a predetermined period of time when the switch transitions between the operating mode and the programming mode, and the first status indication light can be made to blink a number of times equal to the programming node identification label after the latter has been modified.

It will be noted that in the example above, the user programming the switch can use the reset function of the second microswitch whenever need be, for example if this user loses track of the current programming identification node label and wishes to start over from zero.

Once the programming of the switch is done, the method preferably includes an additional step of transitioning the switch from the programming mode to an operating mode through continuously pressing the first microswitch, the second microswitch or both for a predetermined period of time.

Of course, it will be understood by one skilled in the art that any appropriate programming procedure may be considered as part of the scope of the present invention.

A specific example of such a procedure could be as follows. The designations of SW1 and SW2 refer to the two micro-switches of a pair, and LED1 and LED2 refer to the status indicating lights associated therewith.
1. Press both SW1 and SW2 for at least 10 seconds to enter the programming mode. Both LEDs are turned on for 1 second to acknowledge that the programming mode has been successfully activated. The current node ID is then displayed by one of the LEDs. For example, node ID number 3 could be indicated by three short blinks of the LED followed by a long pause. If there is no blinking, the node ID is 0.
2. SW1 is assigned a reset function and SW2 a set function. The node ID is incremented by pressing SW2 the corresponding number of times. For example, the node ID could be changed from 3 to 7 by pressing on SW2 four times.
3. If needed, the node ID may be reset to 0 by pressing the reset micro-switch (SW1).
4. Once the desired node ID is reached, the switch can be returned to normal operation by holding the reset switch for about 3 seconds. The two LEDs are turned on for 1 second simultaneously to indicate the programming mode has been properly exited.

Once reprogrammed, the new node ID is preferably automatically saved into non-volatile memory and is immediately effective.

In summary, the present invention provides a switch for connection to a multiplexing network which is simple, practical and versatile. It will be noted that the two micro-switches of the present switch can be used for controlling one or two independent functions. This is contrary to traditional switches, which are normally used for a single function, for example making contact when pressing on side of the actuator or knob and breaking contact when pressing the other side, or directing supply voltage to two different loads which are mutually exclusive as only one or the other can be active at a given time, not both. The programmable switch according to the embodiments above can be used to do the same function or programmed in a way to independently control two functions; for example, press one button area of the actuator activates function 1 while press the other button area toggles function 2 status. Advantageously, a user of the switch can easily reprogram these functions as the need may be, without the use of external tools.

Of course, numerous modifications could be made to the embodiments above without departing from the scope of the present invention.

1. A programmable switch, comprising:
a control circuit;
a microprocessor connected to the control circuit for controlling an operation of the switch, the microprocessor operating said switch in either one of an operating mode and a programming mode;
a first microswitch and a second microswitch connected to the control circuit, a simultaneous pressing of said first and second microswitches activating the programming mode; and
an actuator for alternately pressing the first microswitch and the second microswitch, said actuator having a first button area and a second button area mounted over and in register with the first microswitch and the second microswitch respectively, such that pressing either of said first and second button areas activates the corresponding one of said first and second microswitches, said actuator being removable to provide simultaneous access to said first and second microswitches.

2. The programmable switch according to claim 1, wherein the actuator is a rocker knob pivotally mounted over the first microswitch and the second microswitch.

3. The programmable switch according to claim 1, further comprising a waterproof shell surrounding the control circuit, the microprocessor and the first and second microswitches.

4. The programmable switch according to claim 3, wherein the waterproof shell comprises a housing having an open end, and a waterproof layer closing the open end.

5. The programmable switch according to claim 4, wherein the housing comprises:
a base portion in which the control circuit is received; and
a top framing portion clickable in position over the base portion and surrounding the control circuit.

6. The programmable switch according to claim 5, wherein the actuator is a rocker knob pivotally mounted over the first microswitch and the second microswitch, the switch further comprising a pivot structure supporting the knob, and the pivot structure being integral to the top framing portion of the housing.

7. The programmable switch according to claim 1, wherein the first and second microswitches are tact-type microswitches each comprising a silicone top button.

8. The programmable switch according to claim 1, wherein the first and second microswitches are dome-type microswitches each comprising:
a microswitch detector and
a silicone plunger mounted over the microswitch detector.

9. The programmable switch according to claim 1, wherein the control circuit comprises a status indicating light in association with each of the first and second microswitches, and the actuator comprises a first pictogram window and a second pictogram window in register with the status indicating light associated with each of the first and second microswitches, respectively.

10. The programmable switch according to claim 2, further comprising knob positioning means for positioning the knob in a neutral position avoiding contact with the first and second microswitches after a downward pressure on the first extremity or the second extremity of the knob is released.

11. The programmable switch according to claim 1, wherein the microprocessor activates the programming mode after the simultaneous pressing of said first and second microswitches for a predetermined period of time within a range of 3 to 8 seconds.

12. The programmable switch according to claim 1, wherein the microprocessor comprises:
a non-volatile memory storing a programming node identification label associated with the switch; and
a programming module for modifying the programming node identification label upon receiving a predetermined sequence of signals from the first and second microswitches when the switch is in programming mode.

13. The programmable switch according to claim 12, wherein, when in programming mode, the programming module:
resets the programming node identification label to a reset value upon activation of the first microswitch; and
increments the programming node identification label by an increment value upon activation of the second microswitch.

14. The programmable switch according to claim 12, wherein:
the switch comprises a first and a second status indication light mounted on the control circuit and controlled by the microprocessor, said first and second status indication lights being respectively associated with the first and second microswitches, and
when in programming mode, the microprocessor commands said status indication lights to provide feedback on a programming of said switch.

15. The programmable switch according to claim 14, wherein said feedback comprises:
activating the first and second status indication lights for a predetermined period of time when the switch transitions between the operating mode and the programming mode;
having the first status indication light blink a number of times equal to the programming node identification label after the programming node identification label is modified by the module.

16. The programmable switch according to claim 1, wherein the microprocessor transitions the switch from the programming mode to the operating mode upon a continuous pressing of a predetermined one of said first and second microswitches for a predetermined period of time.

17. A programmable multi-switching device, comprising:
a control circuit;
a microprocessor connected to the control circuit; and
a plurality of switches connected to the control circuit, the microprocessor operating each switch in either one of an operating mode and a programming mode, and each switch comprising:
a first microswitch and a second microswitch connected to the control circuit, a simultaneous pressing of said first and second microswitches of a selected switch activating the programming mode of the selected switch; and
a removable actuator for alternately pressing the first microswitch and the second microswitch, said actuator having a first button area and a second button area mounted over and in register with the first microswitch and the second microswitch respectively, such that pressing the first either of said first and second button areas and the second button area activates the first corresponding one of said first and second microswitches respectively, said actuator being removable to provide simultaneous access to said first and second microswitches.

18. A method for programming a switch, said switch comprising a control circuit, a microprocessor connected to the control circuit for controlling operation of the switch, a first microswitch and a second microswitch connected to the control circuit, and an actuator for alternately pressing the first microswitch and the second microswitch, said actuator having a first button area and a second button area mounted over and in register with the first microswitch and the second microswitch respectively, such that pressing the first button area and the second button area activates the first microswitch and the second microswitch respectively, said method comprising the steps of:
a) removing the actuator; and
b) simultaneously pressing the first microswitch and the second microswitch to activate a programming mode of the switch.

19. The method according to claim 18, comprising an additional step of:
modifying a programming node identification label associated with the switch through pressing the first and second microswitches in a predetermined sequence.

20. The method according to claim 19, wherein the modifying of step c) comprises:
resetting the programming node identification label to a reset value through activation of the first microswitch; and
incrementing the programming node identification label by at least one increment value through activation of the second microswitch.

21. The method according to claim 19, comprising an additional step of:
providing feedback on a programming of said switch by activating at least one of a first and a second status indication light mounted on the control circuit and controlled by the microprocessor, said first and second status indication lights being respectively associated with the first and second microswitches.

22. The method according to claim 21, wherein the providing of step d) comprises:
activating the first and second status indication lights for a predetermined period of time when the switch transitions between the operating mode and the programming mode; and
having the first status indication light blink a number of times equal to the programming node identification label after the programming node identification label is modified.

23. The method according to claim 19, comprising an additional step of:
e) transitioning the switch from the programming mode to an operating mode through continuously pressing a predetermined one of said first and second microswitches for a predetermined period of time.

24. The method according to claim 18, wherein the actuator is a rocker knob pivotally mounted over the first microswitch and the second microswitch.
